(19) United States
(12) Patent Application Publication
(10) Pub. No.: US 2003/0074529 A1
(43) Pub. Date: Apr. 17, 2003

(54) Bulk storage method and system and autonomous portable bulk storage unit used in such a system

(76) Inventor: Henri Crohas, Verrieres Le Buisson (FR)

Correspondence Address: YOUNG & THOMPSON, 745 SOUTH 23RD STREET 2ND FLOOR, ARLINGTON, VA, 22202

(21) Appl. No.: 09/986,315

(22) Filed: Nov. 8, 2001

(30) Foreign Application Priority Data
Oct. 11, 2001 (FR) 01 13086

(51) Int. Cl. G06F 13/00

(52) U.S. Cl. 711/115

(57) ABSTRACT

A bulk storage system includes an autonomous portable bulk storage unit communicating with a remote emulator card. The card makes it possible to emulate a conventional detachable storage card of the PCMCIA, COMPACT FLASH, SMART MEDIA or MEMORY STICK type. This emulator card is designed to be inserted into a portable device provided with elements for managing the conventional detachable storage card. The communication between the storage unit and the emulator card can be carried out by hard-wire or wireless element, for example by a wireless transceiver plug connectable to the storage unit.

The present invention relates to a bulk storage method and system. It also relates to an autonomous portable bulk storage unit used in such a system. It can be applied advantageously to portable digital devices requiring a high storage capacity.

Many portable digital devices are known which use detachable flash memory cards as a bulk storage unit: portable computers, PDA (Personal Digital Assistant), Pocket PC, MP3 music players, etc. This flash memory card can then be accessed by a microcomputer, either directly or using a USB adapter for example.

Portable digital devices are continuously developing by considerably reducing their size whilst increasing the quality of the processed information. This increase in quality necessitates high capacity storage means. By way of example, for a digital camera, a very good image quality can require up to 18 megabytes. The present detachable memory cards allow the storage of only a limited number of digital photographs. Consequently, a digital camera comprising a detachable memory card has low autonomy. Generally, these detachable memory cards are in a format type such as PCMCIA, COMPACT FLASH, SMART MEDIA, MEMORY STICK, etc.

In order to overcome this data storage problem, there is known for example the KODAK system divulged in an American patent application published with the reference number US 2001/0010543 wherein a digital camera can transmit images directly to the hard disk of a remote microcomputer, optionally connected to the internet, and by means of a specific wireless link. This transmission makes it possible to empty the camera's storage means. But in order to do this, it is necessary for the camera to be designed for this purpose, both from the hardware and software (or “firmware”) points of view.

With regard to data transmission in wireless mode from a portable device, there is known for example in the field of personal digital assistants network cards or wireless modems designed in the form of cards having a PCMCIA, COMPACT FLASH or MEMORY STICK interface. These cards make it possible, for example, to be connected to a local network of the Ethernet type or to the Internet network and to share hard disks on the network. However, it is necessary for the host device on which this modem or wireless network card is connected to identify this card as a network card or a modem card, that is to say it is necessary for the card to present to the host device with the attributes of a network card or modem. Furthermore, specific modem or network management software must be installed in the host device in order to control this network card or this wireless modem. The document No. W00145388 describes a digital camera capable of transmitting images to a storage unit over the Internet. In order to do this, the camera uses a PCMCIA format card in order to carry out a wireless transmission.

Most of the systems of the prior art necessitate the downloading into the portable digital device of dedicated management software, or when such software is pre-installed in the device, the latter is compatible only with the card (modem or network) for which the software is pre-installed.

The purpose of the present invention is to provide a solution to the problem of storage capacity limitation in detachable memory cards by proposing a portable device having a high real time storage capacity and therefore a high autonomy.

The present invention also relates to a high capacity data storage system capable of being adapted to existing conventional portable devices.

One objective of the invention is to considerably increase the storage capacity of a portable device using detachable storage units, this device being able to be digital or not digital.

The said objectives are achieved with a bulk storage system comprising an autonomous portable bulk storage unit. According to the invention, the system furthermore comprises a first transceiver module disposed in the bulk storage unit and a card for emulating a conventional detachable storage card. This emulator card comprises a second transceiver module capable of communication with the first transceiver module. Advantageously, it can be inserted in a portable device provided with means of management of the conventional detachable storage card. The conventional detachable storage card can advantageously be a direct access RAM memory card or a memory disk card of the ATA/IDE or SCSI type, or even a miniature hard disk like the IBM MicroDrive. This conventional card can be chosen from the following non-limitative list of interfaces: PCMCIA, SMART MEDIA, COMPACT FLASH, SD CARD and MEMORY STICK.

The emulator card emulates the conventional detachable storage card whilst being physically and electrically compatible with it.

Generally, portable digital devices have a housing designed to receive a memory card of the said type. It is known that the microcontroller managing such a digital device can access the memory of the detachable memory card in two ways, either directly to the FLASH memory contained in the memory card, or more generally as for a hard disk; in this second case the detachable memory card according to the prior art is configured like a memory disk with an interface of the ATA/IDE or SCSI type.

The invention it particularly noteworthy in that an electronic card is conceived which presents itself to the portable device like a memory card of the prior art provided for that portable device. But in reality, the electronic card according to the invention offers different functions since it does not retain the data that it is asked to store.

The transceiver modules can comprise wireless communication means or hard-wire communication means. In the first case, the first wireless transceiver module can be in the form of a detachable plug. Many wireless transmission systems can be used: it is possible for example to mention the BLUETOOTH protocol, the IEEE 802.11 standard and the WAP (WIRELESS PROTOCOL). These transmission modes make use of microwave links but it is also possible to use infrared according to the IRDA standard. In the second case, the two modules can communicate via a flexible shielded cable enclosing a twisted pair of wires and, preferably, the emulator card furthermore comprises parallel bus/serial bus signal conversion means.

The emulator card can comprise a microcontroller capable of reproducing the input-output registers and functions of a conventional detachable storage card and of transmitting data coming from the said portable device to the bulk storage unit. In other words, the microcontroller is configured in such a way that the emulator card according to the invention identifies itself to the portable device as being a storage means (PCMCIA, COMPACT FLASH, SMART MEDIA, MEMORY STICK, etc). This characteristic has, in particular, the effect of not necessitating a specific downloading of management software into the portable device. The latter manages the emulator card in the same way as it manages the memory cards intended for it: either directly like a RAM memory card or like a hard disk.

Because of this, the bulk storage unit can comprise a hard disk, at least one rewritable optical disk, such as a CD or DVD, or at least one floppy disk.

According to an advantageous characteristic of the invention, the emulator card comprises a buffer memory storing the data coming from the portable device before transmission to the bulk storage unit.

This emulator card according to the invention can furthermore comprise means for the digital compression of the data coming from the device in order to make possible a wireless video transmission. In fact, the device can be a camcorder with a cartridge of the DV (Digital Video) type. In this case a chip for conversion from the DV format (3 megabits per second) into the MPEG4 format is integrated in the DV cartridge emulator card in order to obtain a higher compression rate that is sufficient for a BLUETOOTH transmission at about 700 kilobits per second for example.

The invention is also noteworthy in that it can make it possible for a digital camera to perform video transmission. In order to do this, the emulator card comprises an electronic chip capable of converting series of JPEG images stored at a few images per second in a buffer memory of the card into a continuous MPEG4 video stream, sufficient for a wireless transmission, for example of the BLUETOOTH type. It is also possible to use such a digital camera to carry out video surveillance.

The invention can therefore be advantageously applied to many portable devices provided with a bulk storage cartridge system such as a DV magnetic tape storage cassette, an audio cassette, a diskette or even a floppy or hard disk cartridge (ZIP, JAZ, etc). The device according to the invention therefore makes it possible to emulate the interface with the portable device (digital, magnetic or other) and the extension of the storage capacity is carried out by microwave or infrared link to an autonomous bulk storage unit.

According to another aspect of the invention, there is proposed an autonomous portable bulk storage unit able to comprise a bulk storage means, autonomous power supply means and a microcontroller. This unit can furthermore comprise a transceiver module capable of receiving storage data coming from an emulator card emulating a conventional detachable storage card. The transceiver module can comprise wireless transmission means and can be in the form of a detachable plug provided with connectors for attachment to the remaining part of the storage unit. This plug can furthermore comprise a microcontroller.

The wireless transceiver module is capable of communication within a local wireless network, of being connected to a remote portable digital device using a point-to-point link, or even to a plurality of remote portable digital devices using a point-multipoint link.

In another variant, the invention has a point-to-point link between the storage unit and a remote modem making it possible for it to be connected to the Internet.

According to an advantageous characteristic of the invention, the emulator card according to the invention can emulate a hard disk card and the storage unit can comprise a CD/DVD writer. The portable device sees the emulator card as a hard disk card managed by means of a hard disk file system, for example WINDOWS FAT16 or FAT32. Preferably, the storage unit comprises a CD rewriter (CD-R, CD-RW, DVD-R or DVD-RW). In other words, the storage space of the rewritable medium is seen from the portable device as a hard disk having the size of the medium (650 megabytes for a CD) with a hard disk file management system (FAT16 or FAT32) whilst the rewritable medium, that is to say the CD, is structured according to one of the conventional CD formats with a file management system adapted for rewritable media (ISO9660, UDF, PHOTO CD, etc). This system can advantageously be used with a digital camera since it makes it possible to write the images passing through the emulator card directly onto a Photo CD or an ISO CD without necessitating specific writing software in the digital camera.

According to the invention, the microcontroller of the emulator card or the microcontroller of the storage unit can be configured in such a way as to initiate data exchanges automatically, as in a computer's virtual memory management system.

In the case of use of a buffer memory in the emulator card, the transfer of data from the buffer memory to the storage unit can be initiated as a result of an operation by the user either on the storage unit or on the portable device. In the latter case, the device comprises data transfer control means, such as an icon or a button. According to another method of use, the contents of buffer memory can be dumped automatically, when it is full, into the storage unit. When the portable device in which the emulator card is installed is not a dedicated device, after each dump, the card is reinitialised by simulating a physical removal/reinsertion of the card. In this way the portable device detects an empty memory.

According to one embodiment of the invention, the transceiver module is in the form of an input/output connector designed to connect the storage unit to a remote digital device by means of a cable. The end of the cable provided for coupling with the input/output connector comprises a bus conversion circuit. This conversion can be a serial-parallel conversion between a serial cable and a parallel input/output connector.

Preferably, the autonomous power supply means comprise a rechargeable battery, particularly rechargeable via the cable.

According to yet another aspect of the invention, there is proposed a method of storing data in an autonomous portable bulk storage unit provided with a bulk storage means and with autonomous power supply means. This method comprises a stage of receiving, within the bulk storage means and by means of a wireless transceiver module disposed in the storage unit, digital photographs, sound or video coming from a portable camera, sound recorder or video camera respectively, provided with a corresponding transceiver module. This method can also comprise a stage of transmission from the bulk storage means and by means of a transceiver module disposed in the storage unit, of digital photographs, sound or video to a portable device for reproducing sound or images provided with a corresponding transceiver module.

Other advantages and characteristics of the invention will appear on examining the detailed description of one embodiment, which is in no way limitative, and the appended drawings in which:

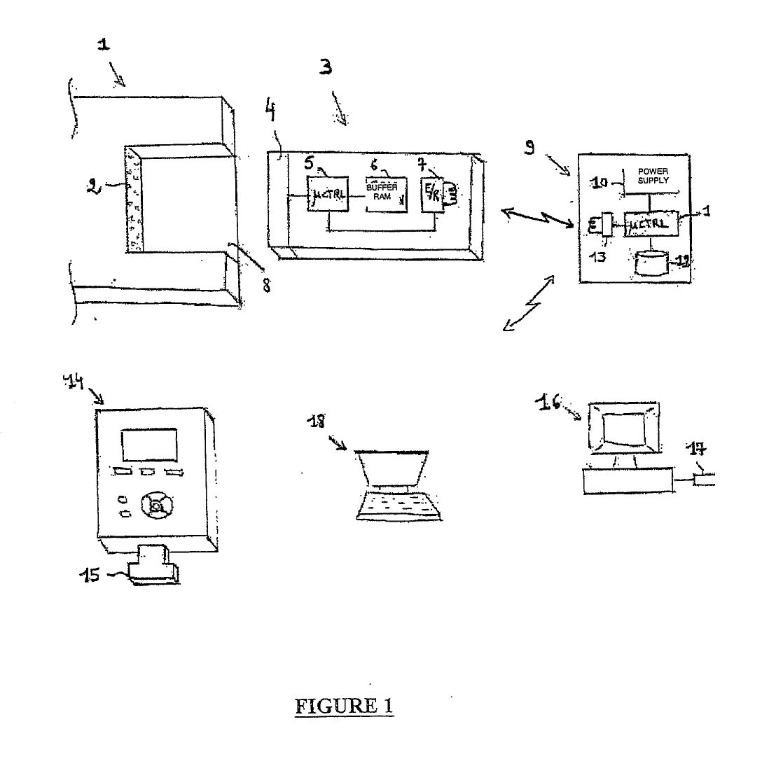

FIG. 1 is an overall diagrammatic view of a wireless transmission system comprising an emulator card according to the invention;

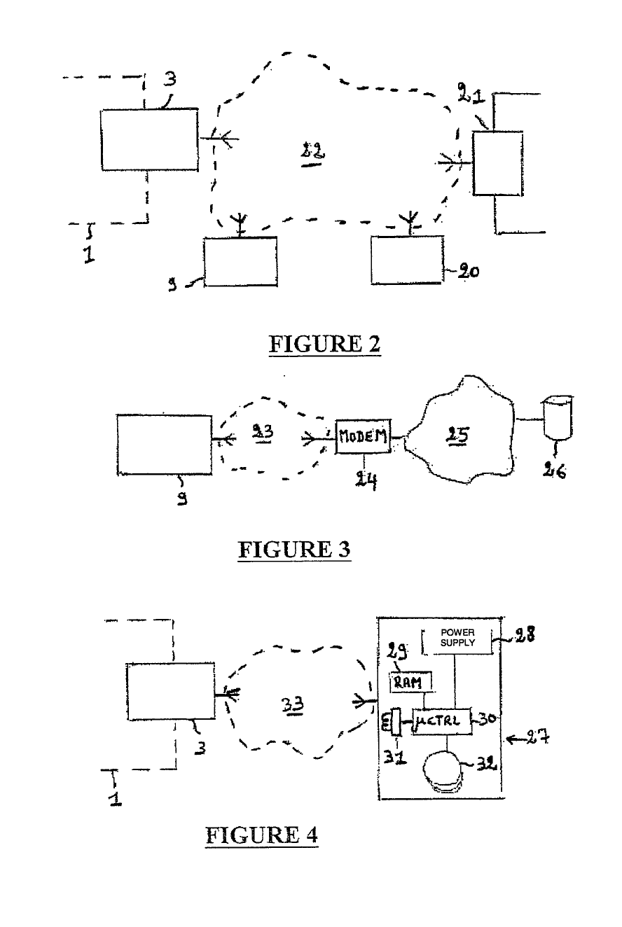

FIG. 2 is a block diagram of a wireless communication network according to the invention;

FIG. 3 is a diagrammatic view of a system using the wireless transmission of an emulator card according to the invention via a modem and to the Internet;

FIG. 4 is a diagrammatic view of a wireless transmission system according to the invention between an emulator card and a CD writer;

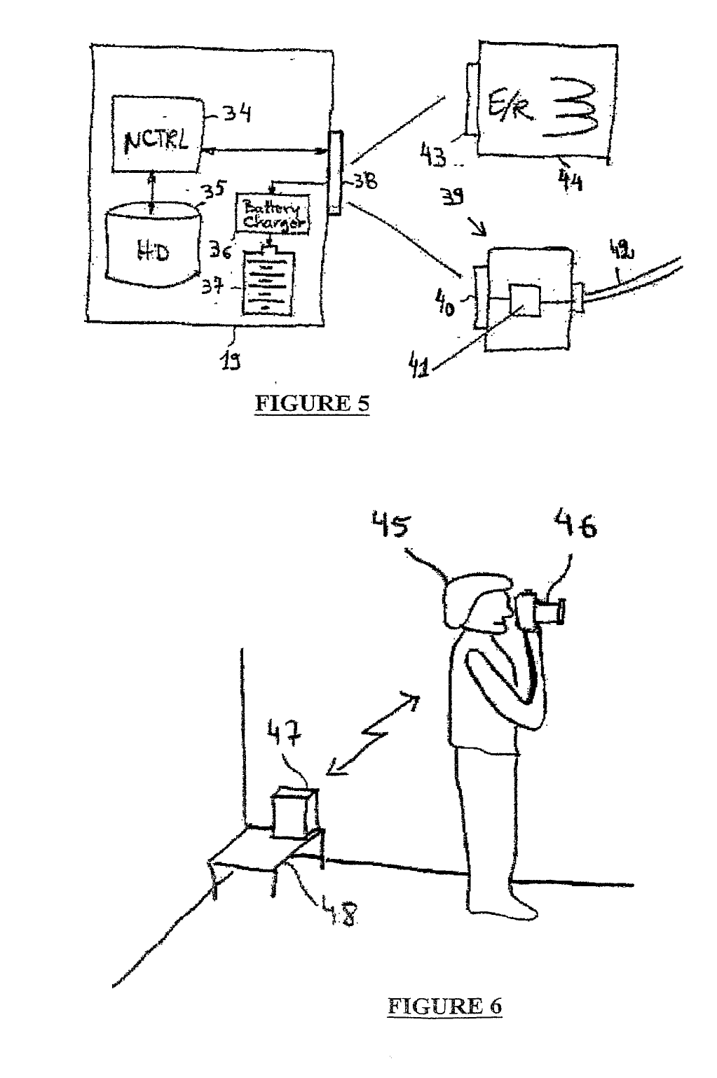

FIG. 5 is a block diagram of a storage unit according to the invention with a hard-wire connector and a wireless connector; and

FIG. 6 is a view of an application according to the invention showing a photographer using a digital camera equipped with an emulator card.

Even though the invention is not thereby limited, there will now be described many systems using a portable digital camera. As mentioned above, the device according to the invention can be applied to any portable device intended to house a detachable storage means. For example it is possible to mention a portable computer, a personal digital assistant, a camcorder or also a portable telephone.

In FIG. 1, there can be seen a portable digital camera 1, only part of which is shown. This camera comprises a housing 8 at the bottom of which are disposed connection means 2, these connections 2 being designed to receive a memory card of the PCMCIA type. The emulator card 3 according to the invention comprises connection means 4 physically and electrically compatible with the connection means 2 of the portable camera 1. This emulator card 3 can have a format identical to that of a memory card of the PCMCIA type in order to facilitate its insertion in the housing 8. A microcontroller 5 present in the emulator card 3 is configured in such a way that this emulator card 3 is identified in the portable camera 1 as a memory card of the PCMCIA type. The communication between this microcontroller 5 and the portable camera 1 is identical to the communication protocol used between that portable camera 1 and a memory card of the PCMCIA type. Consequently, the processing means (not shown) of this portable camera 1 do not have to be reconfigured in order to take the emulator card 3 according to the invention into account. This emulator card 3 can therefore be used by any existing and future type of device capable of communication with a memory card of the PCMCIA type. The present invention can of course be implemented using other memory cards such as SMART MEDIA, COMPACT FLASH or even MEMORY STICK. For most of these cards, the processing means (not shown) of the portable device 1 make it possible to manage them either in RAM memory mode, or in hard disk mode. Advantageously, the microcontroller 5 according to the invention can be managed in both of these modes.

In other words, the detachable memory card (PCMCIA, SMART MEDIA, COMPACT FLASH or MEMORY STICK) is replaced by a physically and electrically compatible card emulating the memory in one or other of the two management modes (memory or hard disk).

The emulator card 3 furthermore comprises a wireless transceiver module 7. Optionally, it is possible to integrate a RAM buffer memory 6 in this emulator card 3. Because of this, the digital images taken by the camera 1 intended to be stored in a memory card of the PCMCIA type are in reality taken into account by the emulator card 3 and transmitted, directly or by passing through the buffer 6, by means of the wireless transceiver module 7.

The wireless transmission can be carried out according to the BLUETOOTH, infrared, or also the IEEE802.11 standard for example. The emulator card 3 is therefore preferably compatible with the IEEE802.11B standard relating to a wireless network. It can therefore operate at a frequency of about 2.5 gigahertz and can authorise a data flow of up to 11 megabits per second, for a transmission distance of up to several hundred metres.

This card can operate in an “Ad Hoc” mode, that is to say in a wireless network without an access point, or in an “Infrastructure” mode, that is to say, in a network using an access point.

The photos taken by the portable device 1 are therefore not stored in the emulator card 3 but transmitted by a wireless link to a remote storage unit. In FIG. 1 there is shown a remote storage unit 9 according to the invention communicating with the emulator card 3 over a point-to-point wireless link.

The remote storage unit 9 is an autonomous hard disk dedicated to the emulator card 3. It comprises a hard disk 12 connected to a power supply 10, a microcontroller 11 and a wireless transceiver module 13.

The downloading of digital photographs to the remote storage unit 9 can be carried out automatically by the microcontroller 5, either directly or by passing through the buffer memory 6. The digital photographs can also be stored temporarily in the buffer memory 6 and their downloading into a remote storage unit can be obtained when initiated by the user of the portable device 1 by controlling either the microcontroller 5 or microcontroller 11. These controls can be obtained by means of a control button disposed on the remote storage unit 9 or on the portable device 1. In the latter case, the portable device 1 can be a preconfigured device. The push button can also be an icon to be clicked insofar as the portable device 1 or the remote storage unit is provided with the necessary means (for example a touch-sensitive screen, browsing software, etc.).

Sometimes, it can be necessary, when the portable device 1 is not a dedicated device, to physically have to disconnect the emulator card 3 and then to reconnect it in that portable device 1 in order to indicate to that device that the memory is empty. As mentioned above, it is also possible to provide software means installed in the emulator card or in the storage unit to allow the portable device to manage the capacity of the hard disk 12. The transceiver module 13 can be in the form of a detachable plug. It is then provided with transmitting and receiving means for microwave signals, optionally a microcontroller for managing the data received and for transmitting it to a connector of the USB type for example. This module 13 is for example configured for wireless communication according to the IEE802.11B standard with the emulator card 3 and for a hard-wire communication with the hard disk 12.

The transceiver modules 13 and 7 are capable of communicating with a digital device such as an MP3 player 14, a fixed computer 16 or a portable computer 18. The MP3 player can then be equipped with a transceiver plug 15 equivalent to the transceiver module 13 in the form of a detachable plug. The fixed computer 16 can then be provided with a wireless communication card of the USB, PCI, MINI-PCI etc type. The data received is stored in a storage means of the computer, for example its internal hard disk or an external hard disk 17 (ZIP, JAZ, etc.). For the portable computer 18, the communication can be carried out by means of an existing wireless network card of the PCMCIA type for example.

In FIG. 2 there again can be seen the portable device 1 provided with an emulator card 3 and the storage unit 9. The antennas placed in this figure indicate that this transmission is a wireless transmission. The emulator card 3 and the storage unit 9 each constitute a station in a wireless network comprising in particular another portable digital device and an access point 21. This access point allows connection, for example, to a local hard-wired network or to the Internet. In this wireless network 22, each element 3, 9, 20 or 21 can act as a server or as a client.

In FIG. 3 there is shown an embodiment in which the storage unit 9 according to the invention transmits data to a modem 24 via a point-to-point wireless network 23. The modem makes it possible to pass the data over the Internet in order to reach a remote storage unit 26.

In FIG. 4, the emulator card 3 is in point-to-point connection with a remote storage unit 27 via a wireless network 33. The remote storage unit 27 is a writer comprising several CD-ROM's, rewritable DVD's 32 or any other compatible medium. The portable device 1 detects the emulator card 3 as being a hard disk having a capacity of 650 megabytes (corresponding to the storage capacity of a CD-ROM), this hard disk being managed by the microcontroller 5 of the emulator card 3 by means of hard disk management software of the FAT16 or FAT32 type. But in reality, the microcontroller 5 transmits all the data to the remote storage unit 27 which is provided with a wireless transceiver module 31, a power supply 28, a RAM memory 29 and a microcontroller 30. The remote storage unit comprises file management software means for rewritable media such as ISO 9660, UDF, PHOTO CD, etc. This remote storage unit 27 can therefore easily manage the writing of CD's 32. The photographs taken by the portable device 1 are therefore directly written onto the CD's 32 without necessitating the presence of specific writing software in the portable device 1.

In FIG. 5 there is shown another embodiment according to the invention. The remote storage unit 19 is provided with a microcontroller 34 for communicating with the exterior and a hard disk 35 for storing data. It also comprises a battery 37 that is rechargeable via a battery charger module 36.

The remote storage unit 19 is provided with a connector 38 intended to receive a complementary connector 40 of an interface card 39 or a complementary connector 43 of a detachable plug 44 for wireless communication. The card 39 comprises a bridge circuit 41 for converting signals transmitted in a serial manner over a wire link 42 by parallel transmission to the connector 40. The link 42 can be of the USB, PCMCIA, IEEE1394, ETHERNET, etc. type. Advantageously, this link makes it possible to power the recharging of the battery 37, this recharging being managed by the battery recharge module 36.

The link 42 can also be a flexible shielded cable containing a twisted pair of wires. This cable is connected at its non-visible end to an emulator card containing logic for converting the signals between a parallel bus and the emulator card (emulating for example a Compact Flash, Smart Media, Memory Stick, etc. card) and the serial bus of the wire.

The present invention therefore makes it possible to increase considerably the storage capacity of portable cameras. But it is above all universal since it can be used in any type of portable device comprising a detachable storage means. In fact, for each portable device it can be designed in such a way as to emulate the detachable storage means intended for that portable device.

In FIG. 6 there can be seen an application of such a system. A professional photographer 45 takes numerous photographs using a digital camera 46 equipped with an emulator card according to the invention. These photographs are not stored in a memory card in the camera but are transmitted directly, via a wireless link, to a high capacity storage unit 47 placed in a stationary manner on a table 48. It is as though the photographer were freely carrying a light compact camera whose memory card contained a capacity identical to that of the storage unit 47.

The invention is of course not limited to the examples which have just been described and many modifications can be applied to these examples without departing from the scope of the invention.

1. Bulk storage system comprising an autonomous portable bulk storage unit, characterized in that it furthermore comprises:
a first transceiver module disposed in the bulk storage unit, and
a card for emulating a conventional detachable storage card, this emulator card comprising a second transceiver module capable of communication with the first transceiver module, this emulator card being able to be inserted in a portable device provided with means of management of the said conventional detachable storage card.

2. System according to claim 1, characterized in that the transceiver modules comprise wireless communication means.

3. System according to claim 1, characterized in that the two modules communicate in a hard-wire manner via a flexible shielded cable enclosing a twisted pair of wires and in that the emulator card furthermore comprises parallel bus/serial bus signal conversion means.

4. System according to one of claims 1 to 3, characterized in that the emulator card comprises a microcontroller capable of reproducing the input-output registers and functions of a conventional detachable storage card and of transmitting data coming from the said portable device to the bulk storage unit.

5. System according to claim 4, characterized in that the emulator card comprises a buffer memory storing the data coming from the portable device before transmission to the bulk storage unit.

6. System according to one of claims 1 to 5, characterized in that the bulk storage unit comprises a hard disk.

7. System according to one of claims 1 to 5, characterized in that the bulk storage unit comprises at least one rewritable optical disk, such as a CD or DVD.

8. System according to one of claims 1 to 5, characterized in that the bulk storage unit comprises at least one floppy disk.

9. System according to any one of the preceding claims, characterized in that the first wireless transceiver module is detachable.

10. System according to any one of the preceding claims, characterized in that the emulator card emulates a conventional detachable storage card whilst being physically and electrically compatible with that conventional detachable storage card which is one of the following detachable storage cards: PCMCIA, SMART MEDIA, COMPACT FLASH, SD CARD and MEMORY STICK.

11. System according to one of the preceding claims, characterized in that the emulated conventional card is a direct access RAM memory card.

12. System according to any one of claims 1 to 10, characterized in that the emulated conventional card is a memory disk card or hard disk card.

13. System according to claim 12, characterized in that the emulator card is organized with a files system different from that of the storage unit, the system comprising means for converting the files system of the emulator card into a files system of the storage unit.

14. Autonomous portable bulk storage unit, comprising a bulk storage means and autonomous power supply means, characterized in that it comprises a transceiver module capable of receiving storage data coming from an emulator card emulating a conventional detachable storage card.

15. Unit according to claim 14, characterized in that it furthermore comprises a microcontroller.

16. Unit according to one of claim 14 or 15, characterized in that the autonomous power supply means comprise a rechargeable battery.

17. Unit according to any one of the preceding claims, characterized in that the transceiver module comprises wireless transmission means.

18. Unit according to claim 17, characterized in that the transceiver module is in the form of a detachable plug provided with connectors for attachment to the remaining part of the storage unit, this plug furthermore comprising a microcontroller.

19. Unit according to claim 17 or 18, characterized in that the wireless transceiver module is capable of communication within a local wireless network.

20. Unit according to any one of claims 17 to 19, characterized in that the wireless transceiver module is capable of being connected to a remote portable digital device using a point-to-point link.

21. Unit according to any one of claims 17 to 20, characterized in that the wireless transceiver module is capable of being connected to a plurality of remote portable digital devices using a point-multipoint link.

22. Unit according to any one of claims 14 to 16, characterized in that the transceiver module is in the form of an input/output connector designed to connect the storage unit to a remote digital device by means of a cable.

23. Unit according to claim 22, characterized in that the end of the cable provided for coupling with the said input/output connector comprises a bus conversion circuit.

24. Unit according to one of claim 22 or 23, characterized in that the power supply means comprise a rechargeable battery that is rechargeable via the said cable.

25. Method of storing data in an autonomous portable bulk storage unit provided with a bulk storage means and with autonomous power supply means, characterized in that it comprises a stage of receiving, within the said bulk storage means and by means of a wireless transceiver module disposed in the storage unit, digital photographs, sound or video coming from a portable camera, sound recorder or video camera respectively, provided with a corresponding transceiver module.

26. Method according to claim 25, characterized in that it comprises a stage of transmission from the said bulk storage means, and by means of a wireless transceiver module disposed in the storage unit, of digital photographs, sound or video to a portable device for reproducing sound or images provided with a corresponding transceiver module.
